(19) United States
(12) Patent Application Publication
(10) Pub. No.: US 2007/0156752 A1
(43) Pub. Date: Jul. 5, 2007

(54) Systems and methods for data retrieval and data maintenance for business (sub)objects

(76) Inventors: Ralf Becker, Mannheim (DE); Stefan Krebs, Mannheim (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/320,622

(22) Filed: Dec. 30, 2005

(51) Int. Cl. G06F 17/00

(52) U.S. Cl. 707/103 X

(57) ABSTRACT

Systems and methods are disclosed for the realization of a generic data handling for an arbitrary number of business (sub)objects that keep data in their respective database tables. In one implementation, the system comprises a set of application program interfaces which interfaces the business (sub)object to other objects and applications. The system also comprises a set of (sub)object specific layers comprising function modules and one generic object buffer layer and one generic database buffer layer capable of storing and handling data sets of different data type at the same time. The system may further comprises a registry of the (sub)objects comprising (sub)objects utilized in the implementation of the application and an object service class that abstractly defines all database-specific actions.

### TECHNICAL FIELD

The present invention generally relates to the field of database management. More specifically, the invention relates to methods, systems, and computer program products for the realization of a generic data handling for an arbitrary number of business (sub)objects that keep data in their respective database tables.

### BACKGROUND INFORMATION

In general, a database is a set of related data stored in a computer in an organized way. In this context, the term organized means that the data is stored in some sort of structure which simplifies access to, and maintenance of, the data. In addition, the data within a database may be further organized through the use of tables, which closely correspond to the original, logical, data definition. Further, one database table may contain the data of a certain type of business (sub)object. The business (sub)object represents a central business object in the real world, such as a purchase order. And normally, one database table contains the data of a certain business (sub)object, for example, administrative data of a sales order header, a sales order item, or a product.

To read or maintain (i.e., create/change/delete) data, the business (sub)object provides a set of Application Programming Interfaces (APIs) which represent the interface of the business (sub)object to other objects and applications. An API is the software interface to system services or software libraries. Further, an API may comprise classes, function calls, subroutine calls, descriptive tags, etc. The APIs may, for example, be used by a User Interface (UI) for the maintenance transaction for the respective business (sub)object. The APIs may also be used from any other program, such as a report to maintain data in a batch process, programs of other business objects to maintain or retrieve data within an online background process, or Business Application Programming Interfaces (BAPIs).

The following are an exemplary standard set of the APIs that a (sub)object needs and provides:
A Read API to retrieve business (sub)object data either from the object buffer (being initially filled from the database buffer or within a maintenance process by a maintain API);
A Maintain API to put new and/or changed data into the business (sub)object's internal buffer (object buffer);
A Save API to insert/update/delete database entries by comparing the respective object buffer and database buffer entries to build up the respective insert/update/delete data tables and calling the respective update function module afterwards to post the entries to the database;
A Refresh API to refresh the object buffer and database buffer tables, respectively, for specified entries (e.g., for a maintenance transaction restart or after a data save to refill all buffers with the actual entries newly retrieved from the database tables); and
A Check API to check, if for specified entries the object buffer entries have been changed compared to the respective database buffer entries and hence, a data save must be performed.

Internally, these APIs may call function modules of the following business (sub)object-specific layers:
Database Update Layer: contains the update function module for the involved database table, as well as eventually linked extension tables, and a history database table of the business (sub)object;
Database Buffer Layer: contains function modules either to retrieve requested entries from the runtime database buffer and if they are not yet therein, it tries to read the entries directly from the database and writes them into the database buffer table or to access the runtime database buffer only, without accessing the database;
Object Buffer Layer: contains function modules either to retrieve requested entries from the runtime object buffer and if they are not yet therein, it tries to read the entries from the database buffer and writes them into the object buffer table or to access the runtime object buffer only, without accessing the database buffer. It also, puts entries into the runtime object buffer after they have been checked by the business object's check modules;
Object Work Area Layer: contains function modules that are called directly by the APIs. From this layer, function modules of the these layers, such as field check layer, object check layer, and object buffer layer are called;
Object Check Layer: contains function modules for all checks that are to be performed for data entries to be maintained. These modules are called by modules from the object work area layer. The check function modules call the business (sub)object-specific check method of the database table-specific object services class implementation; and
Object Field Check Layer: contains function modules which check, if an existing value (in the object buffer) for a certain field may or may not be overwritten by a new value or if an input for a certain field is allowed at all by calling the business (sub)object-specific field check method of the database table-specific object services class implementation. These modules are called by modules from the object work area layer.

Normally, a set of these six layers must be programmed for each business (sub)object and the database tables that store the data that comprises the (sub)object. This results in a significant increase in the required programming time.

Accordingly, there is a need for a solution that reduces the necessary number of APIs that are needed to read and maintain a database. This may be accomplished through the implementation of a set of generic APIs provided to read and maintain data sets of different database tables which are related to various business (sub)objects. Retrieved and maintained data may be kept in one generic object buffer and one generic database buffer. Further, all database specific operations and actions, such as database access, database update, data mapping and field checks, and data consistency checks may be implemented as class methods being derived from one generic abstract object services class. As a result, the object work area layer, object buffer layer, and database buffer layer may be programmed only once.

### SUMMARY

In one aspect of the present invention, a system is provided for the generic handling for an arbitrary number of business (sub)objects that keep data in their respective database tables. The system comprises a set of application program interfaces which interfaces the business (sub)object to other objects and applications; a set of (sub)object specific layers comprising function modules; one generic object buffer layer and one generic database buffer layer capable of storing and handling data sets of different data type at the same time; a registry of the (sub)objects comprising (sub)objects utilized in the implementation of the applications; and a object service class that abstractly defines all database-specific actions.

In another aspect of the present invention, a method is provided for performing a generic handling for an arbitrary number of business (sub)objects that keep data in their respective database tables. The method comprises creating a set of application program interfaces which interfaces the business (sub)object to other objects and applications; creating a set of (sub)object specific layers comprising function modules; creating one generic object buffer layer and one generic database buffer layer capable of storing and handling data sets of different data type at the same time; creating a registry of the (sub)objects comprising (sub)objects utilized in the implementation of the applications; and creating an object service class that abstractly defines all database-specific actions.

In a further aspect of the present invention, a computer-readable medium including program instructions for performing, when executed by a processor, a method for performing a generic handling for an arbitrary number of business (sub)objects that keep data in their respective database tables. The method comprises creating a set of application program interfaces which interfaces the business (sub)object to other objects and applications; creating a set of (sub)object specific layers comprising function modules; creating one generic object buffer layer and one generic database buffer layer capable of storing and handling data sets of different data type at the same time; creating a registry of the (sub)objects comprising (sub)objects utilized in the implementation of the application; and creating an object service class that abstractly defines all database-specific actions.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments of the invention and together with the description, serve to explain the principles of the invention.

FIG. 1 illustrates a block diagram of an exemplary server system environment, consistent with an embodiment of the present invention;

FIG. 2 is a flowchart of an exemplary method, consistent with an embodiment of the present invention; and

FIG. 3 illustrates a block diagram of exemplary software of the server system and their relation to each other, consistent with an embodiment of the present invention.

### DETAILED DESCRIPTION

Reference will now be made in detail to the invention, an examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

Systems and methods that provide the realization of a generic data handling for an arbitrary number of business (sub)objects that keep data in their respective database tables are described herein. An object buffer and database buffer are not implemented for each involved database table separately. Instead, only one single generic object buffer and one single generic database buffer are implemented and thus allow the storing of entries of different database tables generically.

Database table-specific operations such as data retrieval or database update are realized as methods of a singly instantiated class derived from an abstract object services class. As used herein, the term instantiated means, in an object oriented programming environment, an object of a particular class, and, more generally, includes creating an object of a specific class. As used herein, the term class means, in an object oriented programming environment, a user-defined data type that defines a collection of (sub)objects that share the same characteristics. A (sub)object is one instance of the class. The abstract object services class administers the creation of objects and ensures that each implemented class is at most instantiated one time.

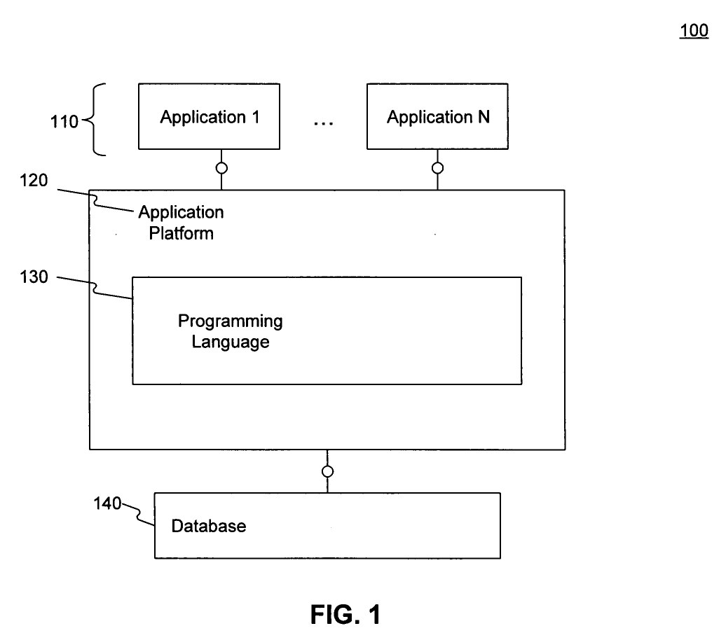

FIG. 1 illustrates a block diagram of an exemplary server system 100 incorporating the present invention. Server system 100 may include one or more processors, such as computers, with an application, such as a database server or an application server. Server system 100 may alternatively include a plurality of databases and application servers, which may be interconnected. In this embodiment, server system 100 may comprise the applications 110, an application platform 120, a programming language 130, and a database and operating system abstraction 140. Application platform 120 is the foundation upon which applications 110 that may access the database 140 are built and run. The application platform 120 may be comprised of a number of functions not specific to certain applications 110. In particular, the application platform 120 may store all generic functions of different business logics (e.g., sales process, purchasing process, etc.) that may be shared by applications 110. Programming language 130 may be any object-oriented programming language capable of database access. Specific examples of programming language 130 are, the Advanced Business Application Programming (ABAP, available from SAP, Walldorf, Germany), Java (available from Sun Microsystems Inc.), and C++.(a royalty free programming language). It should be noted, that although only one programming language is illustrated, the server system 100 may support multiple programming languages.

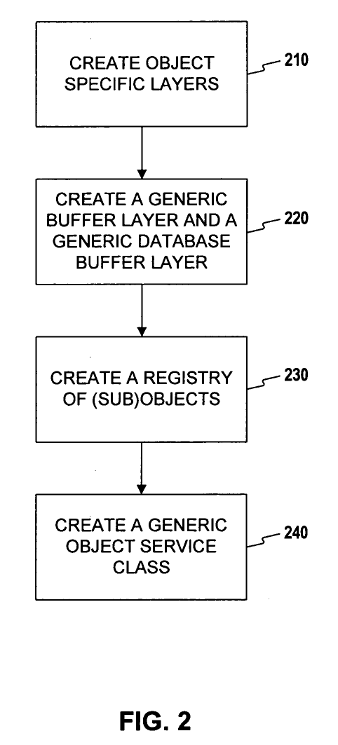

FIG. 2 illustrates a flowchart of an exemplary method, consistent with an embodiment of the present invention. Initially, object specific layers are created (step 210). These object specific layers are organized to store function modules that are specific to a certain task. Exemplary embodiments of object specific layers, such as a database update layer and an object check layer are discussed above. In addition to the object specific layers, generic layers are also created (step 220). These generic layers store a set of generic APIs that are provided to read and maintain data sets of different database tables, which are related to various business (sub)objects. In particular, the retrieved and maintained data may be, for example, stored in one generic object buffer and one generic database buffer.

An object registry is also created, which is utilized as a central repository to store all (sub)objects necessary for the implementation of the applications 110 (step 230). Subsequently, a generic object service class may be created (step 240). All database table-specific operations and actions, such as database access, database update, data mapping and field checks, and data consistency checks are implemented as class methods being derived from this generic abstract service class.

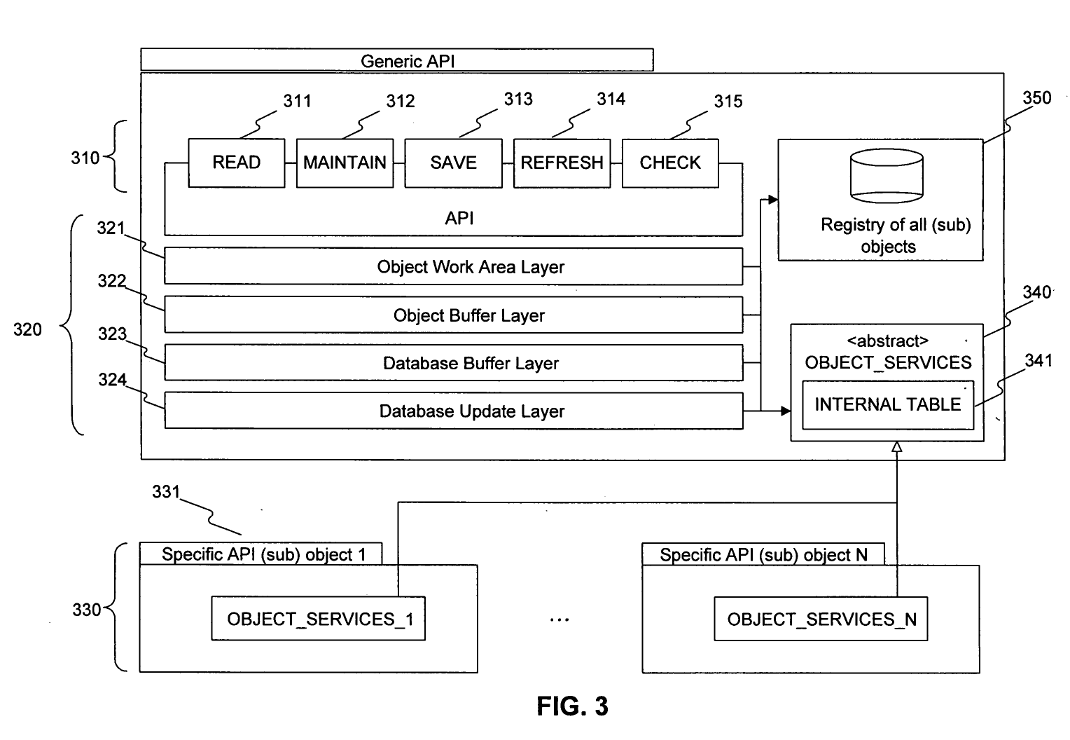

FIG. 3 illustrates an exemplary embodiment of the above discussed software and their interaction. For example, as shown, the software may include an exemplary standard set of APIs 310, which is comprised of a read 311, a maintain 321, a save 313, a refresh 314, and a check 315 API. As described above, these APIs 310 may call function modules of the business (sub)object-specific layers 320. The (sub)object-specific layers may include an object work area 321, an object buffer 322, a database buffer 323, and a database update 324 layer. Normally, a set of these (sub)object-specific layers 320 must be programmed for each business (sub)object 330 and its database table. The object buffer 322 and database buffer 323 tables are directly related to their respective database table and contain its fields, plus additional administrative fields for internal use within the layers. These buffer tables 322 and 323 are declared in their respective programs with a fixed data dictionary structure type.

However, by utilizing the feature of generic data handling with the help of data references available in most object oriented programming languages capable of database access, such as the ABAP programming language, it is possible to build up one generic object buffer layer 322 and one generic database buffer layer 323, capable of storing and handling data sets of completely different data types at the same time. An information line within these generic buffer tables 322 and 323 comprises at first some fixed administrative fields comprising information, such as the name of the underlying database table, the name of the respective data dictionary structure and the key field(s) of the stored record(s). The key fields are utilized to access the related buffer table record. The information line may also contain a field for a generic data type, which is created at runtime with a table type data having the same database-specific structure as the information line type data. For example, the read API 311 has an input data table to specify the key fields of the needed database table entries and the maintain API 312 has an input data table to pass the key fields of records together with the related data sets to be maintained.

All database-specific actions 331 are realized as an implementation of an abstractly defined object services class 340. The methods of this abstract class are themselves defined as abstract, except for a class constructor and a method used for retrieving a specific (sub)object service instance, which for exemplary purposes, may be referred to as a ‘get_instance’ method. The ‘get_instance’ method of the object services class 340 is the only public static method of the class and must be called if the single instance of the class of a given business (sub)object's database table is needed. The class constructor may not be called outside the object services class 340, but only by the ‘get_instance’ method.

The object services class 340 has an internal table 341 containing the already instantiated object classes. If the requested object reference 330 is already contained in the internal table 341, it is retrieved and given back to the calling program. If it is not yet contained in this internal table 341, the requested object 330 is created by calling the object services class constructor method, then entered into the internal buffer table 341 of instantiated objects and given back to the calling program. Further, whenever (sub)object specific logic is needed in one of the layers 320, the abstract object services class is called to provide a buffered instance of the (sub)object specific implementation.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A generic handling system for an arbitrary number of business (sub)objects that keep data in their respective database tables, comprising:
a set of application program interfaces, which interfaces the business (sub)object to other objects and applications;
a set of (sub)object specific layers comprising function modules;
one generic object buffer layer and one generic database buffer layer capable of storing and handling data sets of different data type at the same time;
a registry of the (sub)objects comprising (sub)objects utilized in the implementation of the applications; and
an object service class that abstractly defines all database-specific actions.

2. The generic handling system of claim 1, wherein one line of said buffer tables contains:
fixed administrative fields containing information used to access the related buffer table record; and
a field of generic data type.

3. The system of claim 1, wherein the object services class is called to provide a buffered instance of (sub)object specific implementation whenever (sub)object specific logic is needed in one of the layers.

4. The system of claim 1, wherein the object services class has an internal table containing already instantiated object classes.

5. The system of claim 4, wherein if a requested object reference is already contained in said table, it is retrieved and returned to the calling program and if a requested object reference is not contained in said table, the requested object is created and entered into said internal buffer table.

6. The system of claim 5, wherein the object is created by calling a class constructor method.

7. A method of performing a generic handling for an arbitrary number of business (sub)objects that keep data in their respective database tables, comprising:
creating a set of application program interfaces, which interfaces the business (sub)object to other objects and applications;
creating a set of (sub)object specific layers comprising function modules;
creating one generic object buffer layer and one generic database buffer layer capable of storing and handling data sets of different data type at the same time;
creating a registry of the (sub)objects comprising (sub)objects utilized in the implementation of the applications; and
creating an object service class that abstractly defines all database-specific actions.

8. The method of claim 7, wherein one line of said buffer tables contains:
fixed administrative fields containing information used to access the related buffer table record; and
a field of generic data type.

9. The method of claim 7, wherein the object services class is called to provide a buffered instance of (sub)object specific implementation whenever (sub)object specific logic is needed in one of the layers.

10. The method of claim 7, wherein the object services class has an internal table containing already instantiated object classes.

11. The method of claim 10, wherein if a requested object reference is already contained in said table, it is retrieved and returned to the calling program and if a requested object reference is not contained in said table, the requested object is created and entered into said internal buffer table.

12. The method of claim 11, wherein the object is created by calling a class constructor method.

13. A computer-readable medium including program instructions for performing, when executed by a processor, a method of performing a generic handling for an arbitrary number of business (sub)objects that keep data in their respective database tables, comprising:
creating a set of application program interfaces, which interfaces the business (sub)object to other objects and applications;
creating a set of (sub)object specific layers comprising function modules;
creating one generic object buffer layer and one generic database buffer layer capable of storing and handling data sets of different data type at the same time;
creating a registry of the (sub)objects comprising (sub)objects utilized in the implementation of the applications; and
creating an object service class that abstractly defines all database-specific actions.

14. The computer-readable medium of claim 13, wherein one line of said buffer tables contains:
fixed administrative fields containing information used to access the related buffer table record; and
a field of generic data type.

15. The computer-readable medium of claim 13, wherein the object services class is called to provide a buffered instance of (sub)object specific implementation whenever (sub)object specific logic is needed in one of the layers.

16. The computer-readable medium of claim 13, wherein the object services class has an internal table containing already instantiated object classes.

17. The computer-readable medium of claim 16, wherein if a requested object reference is already contained in said table, it is retrieved and returned to the calling program and if a requested object reference is not contained in said table, the requested object is created and entered into said internal buffer table.

18. The computer-readable medium of claim 17, wherein the object is created by calling a class constructor method.
